(19) United States
(12) Patent Application Publication
(10) Pub. No.: US 2019/0023862 A1
(43) Pub. Date: Jan. 24, 2019

(54) Method of dewatering water soluble polymers

(71) Applicant: Helsingin yliopisto, Helsingin yliopisto (FI)

(72) Inventors: Alistair W.T. King, Helsinki (FI); Ilari Filpponen, Helsinki (FI); Jussi Helminen, Helsinki (FI); Ilkka Kilpeläinen, Helsinki (FI)

(21) Appl. No.: 15/757,380

(22) PCT Filed: Sep. 5, 2016
(86) PCT No.: PCT/FI2016/050615

§ 371 Date: Mar. 5, 2018

(30) Foreign Application Priority Data
Sep. 3, 2015 (FI) 20155635

(51) Int. Cl. C08J 9/28; C08B 1/00

(52) U.S. Cl. CPC C08J 9/28; D21C 9/18; C08J 2301/02; C08B 1/003

(57) ABSTRACT

Method of dewatering nanocellulose and other water soluble of hydrophilic polymers. The method comprises providing an aqueous suspension formed by nanocellulose in water, said nanocellulose having free hydroxyl groups; mixing the aqueous suspension with an ionic liquid or eutectic solvent which is capable of hydrogen bonding to at least a part of the free hydroxyl groups to form a modified suspension; and evaporating off water from the modified suspension in order to dewater the nanocellulose. With the ionic liquid procedure, solvent exchange with repeated centrifugation steps can be avoided, and solvent consumption and costs reduced, and processing sped up. The nanocellulose stabilized in the water-free environment then allows for access to efficient and thorough water-free chemical modification procedures resulting in highly fibrillated products.

### FIELD OF INVENTION

The present invention relates to treatment of polymers, such as nanocellulose, containing water. In particular the present invention concerns a method of dewatering such polymers.

### BACKGROUND

New methods for production and use of nanocelluloses are being developed within the cellulose research community and biomass-based industries. Many of the proposed applications include utilizing nanocelluloses for their strength and for their barrier properties. However, so far few if any high-volume successful commercial applications have appeared.

Nanocelluloses are typically prepared by chemical and/or mechanical fibrillation of cellulosic biomass. In the case of cellulose nanocrystals (CNCs) chemical methods degrade amorphous regions in nanofibrillar cellulose to give high aspect ratio ‘crystallites’. Chemical methods can also be employed to increase the electrostatic charge on the surface of nanocelluloses to allow for greater repulsion between surfaces and hence suspension in molecular solvents.

The result of the preparation methods is that the nanocellulose obtained has free hydroxyl or acid groups and is highly hydrophilic. It is typically provided in the form of an aqueous suspension or dispersion having a solid matter content of up to 10 wt-%, typically less than <4 wt-%. Such suspensions are gel-like. Some researchers have reported dispersions with solid matter concentrations as high as 45% by weight, but such dispersions are very thick and difficult to process and in practice impossible to pump.

One of the key challenges to commercialisation of nanocellulose is therefore the removal of water from nanocellulose so it can be further composited, chemically modified or generally formed into a particular shape.

With current dewatering strategies this is typically very energy intensive.

Some nanocelluloses can be effectively spray-dried but water contents of the resulting celluloses can still be quite significant.

A common laboratory method of completely removing water from nanocelluloses is solvent exchange with typically dipolar aprotic solvents, such as N,N-dimethylformamide (DMF). This requires successive suspension in the dipolar aprotic solvent and centrifugation cycles to isolate progressively dryer nanocellulose in a relatively non-aggregated state. This is very process intensive but the best existing method to get the water content down to low concentrations.

In the patent literature, a number of processes have been suggested for dewatering of nanocellulose.

WO2014072886A1 discloses a method for drying nanofibrillated polysaccharide to obtain a substantially dry nanofibrillated polysaccharide product, comprising the steps of providing an aqueous suspension of nanofibrillated polysaccharide; increasing the solid content of said suspension, thereby forming a high solid content microfibrillated cellulose suspension; and drying said high solid content microfibrillated cellulose suspension, through a simultaneous heating and mixing operation.

WO2012156880A1 discloses a process for dewatering a slurry of microfibrillated cellulose wherein the slurry is subjected to an electric field, which causes the liquid of the slurry to flow and separating the liquid from the microfibrillated cellulose.

WO2014096547A1 discloses a method for producing dewatered microfibrillated cellulose (MFC) comprising the steps of providing an aqueous MFC slurry, dewatering said MFC slurry by mechanical means to provide a partly dewatered MFC slurry, and subjecting the dewatered MFC slurry to one or more drying operations by means of one or more absorbing materials to produce dewatered MFC.

WO2015068019A1 relates to a process for dewatering a slurry comprising a microfibrillated cellulose wherein a slurry comprising a microfibrillated cellulose and a liquid is subjected to a first mechanical pressure in order to dewater the slurry, and the slurry is then subjected to a second mechanical pressure which is higher than the first pressure.

EP2815026A1 discloses a method for processing fibril cellulose which is in the form of aqueous fibril cellulose gel which method comprises lowering the pH of the aqueous fibril cellulose gel to provide aqueous fibril cellulose gel of reduced water retention capacity, and dewatering the aqueous fibril cellulose gel of reduced water retention capacity to provide dewatered fibril cellulose. The dewatering is performed by pressure filtration.

WO2010019245A1 discloses a method in which a mixture of microcrystalline cellulose and water is admixed with an ionic liquid. The water is removed for example with the aid of reduced pressure, distillation or by heating, so that the cellulose dissolves. Specifically, water removal was shown to enhance the dissolution of the cellulose. The dissolved cellulose is esterified to form for example cellulose acetate, which is used in protective films for LCDs.

WO2009101985A1 relates to the preparation of an electroconductive cellulose composition wherein a dispersion gel of carbon nanotubes and an ionic liquid is mixed with cellulose and water to form dispersion liquid. It is not shown that any nanoscaled structure is preserved or generated when the conductive compositions are prepared.

All of the above methods are energy consuming containing the use of excessive pressures or temperatures, which risk thermally or physically damaging the structure of the fibrillated nanocellulose material. In spite of the tedious operations of the known methods, the dewatering results will still be on an unsatisfactory basis and the nanocellulose may become at least partially aggregated.

WO2012089929A1 discloses a method of manufacturing hydrophobic microfibrillated cellulose whereby the dewatering problem caused by the hydrophilic material can at least in theoretically be avoided. In the method an organic hydrophobization reagent is reacted with substituents on the surface of the microfibrillated cellulose, in an aqueous dispersion, by using, as hydrophobization reagent, alkenyl succinic anhydrides (ASAs) and by carrying out an azeotropic distillation. Although some hydrophobization of the nanocellulose and removal of water can be reached, ASAs and other chemical reagents typically react with water incurring considerable process costs due to consumption of reagent and the need for additional purification steps to remove the by-products. Furthermore, the resulting material will have properties, which are different from those of the starting nanocellulose material, which strongly limits the applicability of the products thus produced.

Thus, there is a need for new technology for removing water from water soluble or hydrophilic polymers, such as from nanocellulose, in particular from hydrophilic nanocellulose.

### SUMMARY OF THE INVENTION

It is an aim of the present invention to remove at least some of the problems relating to the art and to provide a new method of dewatering polymers.

It is another aim of providing for new uses of ionic liquids and deep eutectic solvents.

The present invention is based on the concept of using ionic liquids and eutectic solvents as auxiliary agents in dewatering of water-containing polymer suspensions.

Thus, the present method comprises mixing at least one ionic liquid or eutectic solvent with the polymer provided in the form of an aqueous slurry to form a mixture. The ionic liquid or eutectic solvent is selected such that it does not essentially dissolve the polymer. The polymer of the aqueous slurry is essentially unmodified.

As mentioned above, the present method is particularly suitable for dewatering nanocellulose. In relation to such polymers the ionic liquid or eutectic solvent is selected such that it does not essentially dissolve the polymer, which means that the nanocellulose has at least some free hydroxyl groups.

It has been found that ionic liquids and eutectic solvents of the foregoing kind will stabilize the polymer, such as nanocellulose, so that it will be possible to remove water by conventional physical means, for example by evaporation or absorption, without the polymer in particular nanocellulose, undergoing significant aggregation when the water content is reduced.

More specifically, the method according to the present invention is mainly characterized by what is stated in the characterizing part of claim 1.

The use according to the present invention is characterized by what is stated in claim 27.

Considerable advantages are obtained by the invention. Thus, whereas existing procedures for dewatering into an organic solvent typically require solvent exchange with repeated centrifugation steps, in the present method repeated processing steps are cut out, which reduces solvent consumption, and speeds up the process and reduces costs.

When applied to dewatering of nanocellulose, the nanocellulose will be obtained in essentially non-aggregated form. The nanocellulose can readily be transferred to further processing either in the solvent phase formed by the ionic liquid or eutectic solvent, or in a convention organic solvent after a step of solvent change.

Thus, the nanocellulose stabilized in the water-free environment allows for access to efficient and thorough water-free chemical modification procedures resulting in highly fibrillated products.

Further features and advantages of the present technology will appear from the following description of some embodiments.

### BRIEF DESCRIPTION OF DRAWINGS

In the drawings,

FIG. 1 is a simplified process scheme showing one embodiment for removal of water and further potential process steps, including sequences of one or several of compositing, chemical modification or regeneration steps;

FIG. 2 is a diagram showing the particle size distribution of the starting Hemlock CNC dispersed in water (top) compared to the TEGO® P9 ionic liquid-dewatered material dispersed in DMF (bottom);

FIG. 3 is a diagram showing the particle size distribution of the starting Cotton CNC dispersed in water (top) compared to the TEGO® P9 ionic liquid-dewatered material dispersed in DMF (bottom);

FIG. 4 is a diagram showing the particle size distribution of the starting Cotton CNC dispersed in water (top) compared to the [emim][OTf] ionic liquid-dewatered material dispersed in DMF (bottom);

FIG. 5 is a diagram showing the particle size distribution of the starting Birch NFC dispersed in water (top) compared to the TEGO® P9 ionic liquid-dewatered material dispersed in DMF (bottom);

FIG. 6 is a diagram showing the particle size distribution of the starting Birch NFC dispersed in water (top) compared to the [emim][OTf] ionic liquid-dewatered material dispersed in DMF (bottom); and

FIG. 7 is a diagram showing the reduction in water content in the ionic liquid-nanocellulose-water slurries upon drying in the presence of the ionic liquids.

FIG. 8 is a SEM analysis of an Ac-NFC film showing fibrillary structure ranging from approximately 10-15 nm (˜5-10 AGU fibril diameter using 8.2 Å per H-bonded unit in the cellulose Ibeta crystal structure and ˜5 nm for the sputtered layer).

FIG. 9 shows an HSQC NMR of AcNFC film, derived from birch pulp, in 1:4 [P₄₄₄₄][OAc]/DMSO-d6 with corresponding assignments for acetylated cellulose and xylan.

FIG. 10 illustrates a later DOSY increment showing Ac-NFC acetylation, where fast diffusing (low molecular weight) overlapping species are not present.

### DESCRIPTION OF EMBODIMENTS

The following description relates to embodiments involving dewatering of nanocellulose.

For the sake of order it should be pointed out that the present technology can be applied generally to water soluble polymers and other hydrophilic polymers, such as polyelectrolytes, polymer gels and superabsorbent polymers. Examples of superabsorbent polymers include polymers based upon acrylic acid or acrylamide which commonly are prepared in water or aqueous gel state. Generally, the water soluble polymers or hydrophilic polymers have free functional groups to which the ionic liquid or eutectic solvent is capable of forming hydrogen bonds, ionic bonds or other persistent charged interactions.

In the method the ionic liquid or eutectic solvent forms hydrogen bonds, ionic bonds or other persistent charged interactions to at least a part of the functional groups on the polymer such that a modified suspension is formed. Then water can be removed, e.g. physically, from the modified suspension in order to dewater the polymer.

In the present context, “nanocellulose” stands for a material formed from nanosize cellulose fibrils having a high aspect ratio. Typically, the fibrils have a thickness (maximum diameter) in the range of 5 to 100 nanometers, for example 5 to 20 nanometers, and typically a length greater than 1 micrometer, for example about 1 to 10 micrometer.

The individual microfibrils are typically at least partly detached from each other. The nanocellulose may also be in the form of ‘nanocrystals’, which are also derived from nanosized cellulose fibrils. They also have a high aspect ratio. Typically, the nanocrystals have a thickness (maximum diameter) in the range of 5 to 100 nanometers, for example 5 to 20 nanometers, and typically a length in the nanometer scale, for example about 100 nanometers to 1 micrometer.

Elementary fibrils can have a thickness of about 4 nanometers or more.

As a material, the nanocellulose is conventionally pseudo-plastic and typically exhibits properties of thixotropy.

Nanocellulose is prepared from a cellulose material, usually from wood pulp. Pulps that can be used comprise chemical wood-based pulps, including bleached, half-bleached and unbleached pulps produced by alkaline, acid or neutral pulping methods. The pulping methods also include organic pulping methods. In addition to conventional chemical pulps suitable for paper and cardboard, also dissolving pulps can be used. Such pulps typically have a low content, e.g. 5% or less, of hemicelluloses.

For the purpose of the present invention, the term “nanocellulose” covers, e.g., the following species and related synonyms: nanowhiskers, cellulose nanocrystals (CNCs), microfibrillated cellulose (MFC), nanocrystalline cellulose (NCC), nanofibrillated cellulose (NFC) and bacterial nanocellulose (BNC).

Nanocelluloses prepared from wood pulp are used for example in composite materials, non-wovens, adsorbent webs, paper and board, food products, paper and board coatings, cosmetics and toiletry, and filter materials.

Further, nanocellulose can also be obtained from bacterial (“bacterial nanocellulose, BNC), for example bacteria of the strain Gluconacetobacter xylinus (also known as Acetobacter xylinum). BNC has also been used for a variety of commercial applications including textiles, cosmetics, and food products, and it has a high potential for medical applications.

In the present context, “dewatering” of nanocellulose or a suspension thereof, means that liquid, in particular water, is removed and that the solids content of the nanocellulose or nanocellulose suspension is increased.

As was discussed above, the present technology provides a method of dewatering nanocellulose, in particular when the nanocellulose is provided in the form of an aqueous suspension. In the present context, the term “suspension” is used synonymously with “slurry” or “dispersion”.

“Ionic liquid” is a salt which has a melting point of 100° C. or less. The ionic liquid comprises an anion and a cation. “Molten salts” are salts that melt above 100° C. and may also be useful for the purpose described herein. It is understood that this definition of an ionic liquid is tentative due to the use of the arbitrary melting temperature, which is close to the desired processing conditions.

“Eutectic solvent” or “deep eutectic solvent” (these terms are herein used interchangeably) is an ionic solvent, containing two or more components, which forms a eutectic mixture, with a melting point which is lower than that of its individual components. The melting point may even be below room temperature, even if the individual components have melting points up to hundred degrees higher.

In this regard the ionic liquids and eutectic mixtures may also be considered as “electrolytes” on their own or in the presence of additional co-solvent components, such as water.

The ionic liquid, eutectic solvent or deep eutectic solvent, respectively, is selected such that it does not or does not essentially dissolve the polymer. Preferably the ionic liquid, eutectic solvent or deep eutectic solvent, respectively, is also miscible with water. In particular, it is miscible with water at a temperature falling between the freezing point and the boiling point of water at prevailing pressure. Typically, in one embodiment, the ionic liquid, eutectic solvent or deep eutectic solvent, respectively, is miscible with water at a temperature in the range of about 0.5 to 99.5° C., or 5 to 90° C., at normal pressure.

The ionic liquid or eutectic solvent (including deep eutectic solvent) is typically mixed with the water soluble polymers or hydrophilic polymers, in particular nanocellulose, at or at about room temperature, i.e. at about 10 to 35° C., for example at 15 to 30° C., although it is possible to operate at higher and lower temperatures between the freezing point and boiling point of water.

Typically, the nanocellulose has free hydroxyl or acid groups, for example, carboxylic or sulphuric. In particular, there can be on an average 0.1 to 3, in particular 1 to 3 free hydroxyl or acid groups per each anhydroglucose unit of the nanocellulose molecule. The acid groups may also be ionized as metal salts.

As indicated above, nanocellulose is usually provided in the form of an aqueous suspension or slurry, or even a sponge or gel, after production. The concentration of nanocellulose in an aqueous suspension of nanocellulose can be up to 45%, calculated from the total weight of the suspension.

In one embodiment, the aqueous suspension of nanocellulose contains about 0.1 to 15%, in particular about 1 to 10% of nanocellulose, calculated from the weight of the aqueous suspension. It is preferred that the aqueous suspension of nanocellulose is free-flowing or pumpable as such or at least after the addition of the ionic liquid or eutectic solvent.

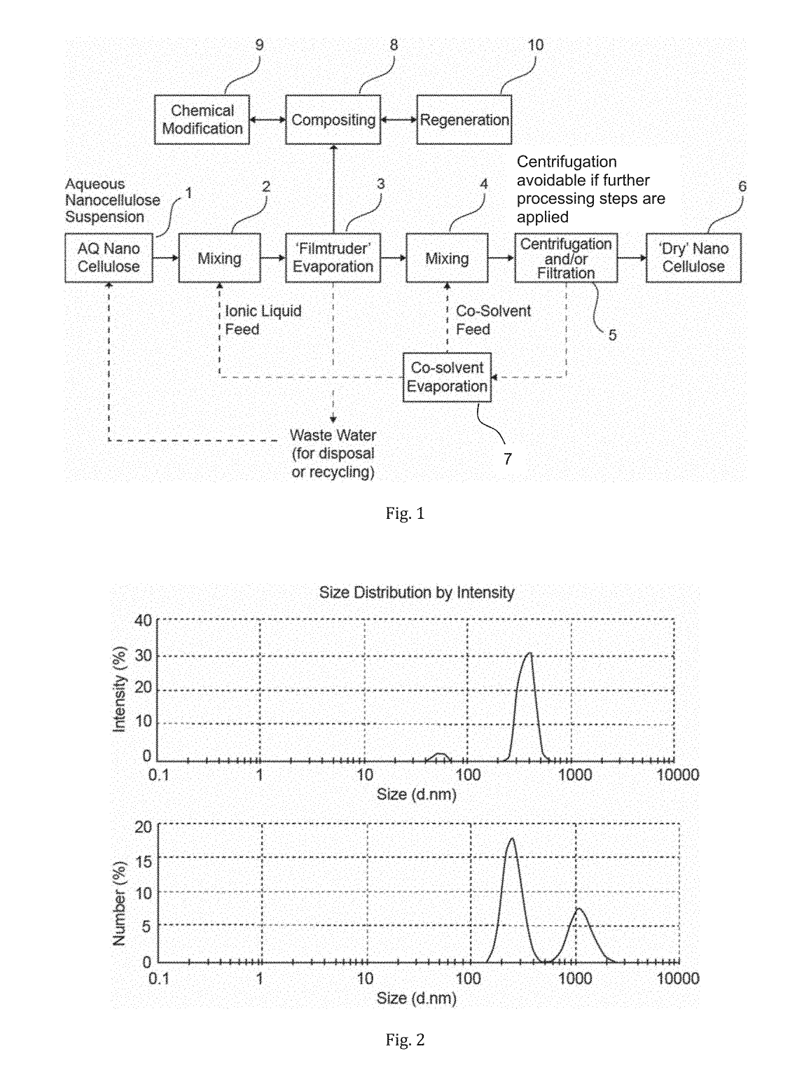

The process scheme of FIG. 1 illustrates an embodiment of the present technology applied to nanocellulose.

Although the following embodiments, which are depicted in detail, are related to nanocellulose, the corresponding method steps can also be applied to water soluble polymers and other hydrophilic polymers.

As will appear from FIG. 1, an aqueous suspension of nanocellulose 1 is mixed with an ionic liquid or eutectic solvent, which is capable of hydrogen bonding or charge stabilising to at least a part of the free hydroxyl or acid groups to form a modified suspension 2.

In one embodiment, the nanocellulose is selected from the group of nanowhiskers, microfibrillated cellulose, nanocrystalline cellulose, nanofibrillated cellulose, and bacterial nanocellulose and combinations thereof.

In the mixing step 2, the ionic liquid is mixed with the aqueous suspension at a weight ratio of about 1 to 100 parts of ionic liquid to 100 to 10 parts of water of the aqueous suspension, preferably at a weight ratio of about 1 to 20 parts of ionic liquid to 99 to 80 parts of aqueous suspension.

The mixture or modified suspension 2 is then subjected to a physical operation 3 for removing water. For example, water can be evaporated off in order to dewater the nanocellulose. However, separation can also be carried out by other physical means, such as adsorption.

For enabling a physical separation step involving evaporation, the ionic liquid or eutectic solvent is essentially non-volatile at the conditions at which water is evaporated off the modified suspension.

Further, the ionic liquid or eutectic solvent does not dissolve or solvate the nanocellulose at the conditions at which it is mixed with the aqueous suspension and at which water is evaporated off in the step 3. Preferably, the ionic liquid or eutectic solvent is miscible with water.

Thus, it is preferred that less than 10% by weight, in particular less than 5% by weight, preferably less than 1% by weight of the nanocellulose is dissolved into the ionic liquid or eutectic solvent phase of the mixture.

Although dissolution is to be avoided, it has been found that partial swelling or recrystallizing of the nanocellulose by the ionic liquid or eutectic solvent is acceptable for the operation of the present technology. Even in that case, there will be nanocellulose particles or solids present in the modified suspension.

And as a third criterion, it is preferred that the ionic liquid or eutectic solvent mixed with nanocellulose suspension stabilizes the surface of the nanocellulose, in particular by forming hydrogen bonds, such as to prevent agglomeration of nanocellulose when water is evaporated off the aqueous suspension

Generally, the ionic liquid or eutectic solvent (including deep eutectic solvent) is preferably selected from ionic liquids and eutectic solvents which do not dissolve the polymer and which are miscible with water. In particular, the ionic liquid or eutectic solvent (including deep eutectic solvent) does not dissolve cellulose at the conditions at which it is mixed with the aqueous suspension and at which water is evaporated off.

In one embodiment, the ionic liquid or eutectic solvent is selected from the group of
diethyl(polypropoxy)methylammonium chloride, provided by Degussa under the tradename of TEGO® P9

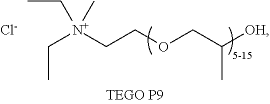

1-ethyl-3-methylimidazolium trifluoromethanesulphonate, commonly abbreviated [emim][OTf]

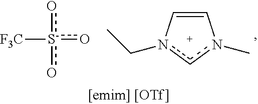

and
eutectic mixtures of choline chloride and urea,

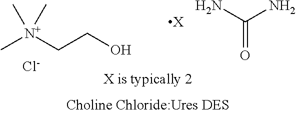

wherein X indicates the mole ratio of urea to choline chloride required for obtaining an eutectic mixture, and “DES” is an abbreviation for deep eutectic solvent, and
combinations of the foregoing.

The mixing and the evaporation steps can be carried out at the same or different conditions.

In one embodiment, the step of mixing the aqueous suspension of nanocellulose with ionic liquid is carried out at a first pressure and at a first temperature, which is higher than the freezing point of water and lower than the boiling point of water.

In one embodiment, the step of evaporating off water 3 from the modified suspension is carried out at second pressure, which is the lower than the first pressure.

Thus, the step of evaporating off water can be carried out at reduced pressure (partial vacuum). For example, evaporation can be carried out at a pressure of 0.1 to 500 mbar(a), in particular 1 to 100 mbar(a), and preferably at a temperature corresponding to the boiling point of water at that pressure. That temperature can be lower, the same or higher than the temperature used during the mixing step 2.

Generally, the step of evaporating off water can be carried at a pressure of 0.001 to 1 bar(a), for example 0.1 to 750 mbar(a), advantageously 0.5 to 500 mbar(a), in particular 1 to 100 mbar(a), and preferably at a temperature corresponding to the boiling point of water at that pressure.

The use of reduced pressure offers flexibility of operation since the temperature can be varied depending on how sensitive the nanocellulose material is to temperature. Potentially higher space-time yields and lower residence times are obtained than under harsher conditions.

However, water can also be removed at atmospheric pressure (1013.25 mbar) if the nanocellulose is stable under these boiling conditions. By this, the need for reduced pressure (“vacuum”) can be avoided.

Typically, in the step of evaporating off water from the modified suspension is carried out at a second temperature, which is higher than the first temperature, irrespective of the pressure employed during evaporation 3.

Evaporation can be carried out in a thin-film evaporator, a rotary evaporator, a falling film evaporator, a filmtruder evaporator, a kugelrohr evaporator or a short- or long-path evaporator or a corresponding distillation device where there is an energy efficient path where water can be flashed off.

The residue obtained after evaporation 3 of water, comprising non-agglomerated nanocellulose and ionic liquid or eutectic solvent, is recovered and subjected to further processing.

The present method does not require any subsequent separation step after evaporation, but the residue after the evaporation can be used as such.

However, in some embodiment, the residue is recovered and the ionic liquid or deep eutectic solvent is separated from the residue.

In some embodiments, the residue is recovered and subjected to solvent exchange 4, 5.

A co-solvent can be used to extract the ionic liquid from the evaporation residue formed by the ionic liquid-nanocellulose suspension. The solid nanocellulose can then be separated and recovered as such 6 or it can be reintroduced into a solvent for further modification.

Typically, the nanocellulose can be regenerated in the form of fibres, films or other molded shapes or objects using a solvent, for example a protic solvent, or a chemical reagent, which is added to wash away the ionic liquid or eutectic solvent.

Thus, in some embodiments, the residue is typically mixed 4 with an organic solvent at a molar ratio of 0.1 to 10:1 of organic solvent to the ionic liquid or eutectic solvent of the residue.

The solvent used 4 can be an organic solvent selected from the group of N,N-dimethylformamide, dimethylsulfoxide, N,N-dialkylureas, N-alkylpyrrolidones, dialkylcarbonates, gamma-valerolactone and acetone, or other similar dipolar aprotic solvents to form a mixture. The solid matter is optionally separated from the mixture to provide dry nanocellulose 6.

In preferred embodiments, the co-solvent is volatile so films can be cast and it can be distilled out of the ionic liquid again 7.

In alternative embodiments, the residue 8 after the physical separation operation 3 is subjected directly to chemical modification 9 where the cellulose surfaces are modified but the ionic liquid remains unreacted or can be regenerated 10.

Generally, only one centrifugation step 5 is needed for removing the ionic liquid or eutectic solvent after the evaporation step, if so desired.

The centrifugation step 5 may leave traces of ionic liquid, which generally are not detrimental to further processing of the nanocellulose. However, to reach a higher level of purity, depending on the different process conditions and requirements for further processing of the nanocellulose, a second centrifugation step may be carried out.

On the other hand, centrifugation 5 is avoidable if further processing steps are applied. Alternatively, the ionic liquid or eutectic solvent may be removed by membrane filtration methods, such as nanofiltration, ultrafiltration and microfiltration.

The liquid phase of the mixture is recovered and recycled. The co-solvent can be separated by evaporation 7 and optionally recirculated to mixing stage 4. Such evaporation 7 typically leaves a residue that essentially contains ionic liquid or eutectic solvent, which can be recirculated to the first mixing step 2.

The nanocellulose provided at 6 contains less than about 10% water, in particular less than 5% water, for example less than 1% water, calculated from the total weight of the nanocellulose.

Further, the nanocellulose provided at 6 contains less than about 20%, for example less than 10%, in particular less than 5%, or even less than 1% aggregated nanocellulose matter, calculated from the total weight of the nanocellulose.

In one embodiment, the residue obtained after evaporation of water, comprising non-agglomerated nanocellulose and ionic liquid or eutectic solvent, is recovered. It can then be regenerated as fibres, films or other molded shapes by addition of solvents, preferably protic solvents, such as water and aliphatic or aromatic alcohols or mixtures thereof, to wash away the ionic liquid or eutectic solvent.

In one embodiment, the residue obtained after evaporation of water, comprising non-agglomerated nanocellulose and ionic liquid or eutectic solvent, is subjected directly to chemical modification where the cellulose surfaces are modified but the ionic liquid remains unreacted. This facilitates a water-free chemical modification of the nanocellulose surface. The ionic liquid may be recovered and circulated in the process, enabling a continuous process for conversion of NFC aqueous suspensions into redispersible nanocelluloses under water-free conditions.

Preferably, the process is carried out as a one-pot process, comprising dewatering and water-free chemical modification of nanocellulose in ionic liquids.

Based on the above, the present technology gives rise to the use of ionic liquids and eutectic solvents as auxiliary agents in dewatering water soluble and hydrophilic polymers, including nanocellulose, provided in the form of an aqueous suspension of nanocellulose in water.

In one embodiment of the use the ionic liquid or eutectic solvent does not essentially dissolve the polymer, such as nanocellulose. In another embodiment, the ionic liquid or eutectic solvent is mixed with the aqueous suspension at a weight ratio of about 10 to 100 parts of ionic liquid or eutectic solvent to 100 to 10 parts of water of the aqueous suspension, preferably at a weight ratio of about 1 to 20 parts of ionic liquid or eutectic solvent to 99 to 80 parts of aqueous suspension.

The following non-limiting examples illustrate embodiments of the present technology applied to nanocellulose.

### Example 1—Dewatering Hemlock CNCs in TEGO® IL P9

10 ml of Blue Goose Biorefineries BGB Natural™ 7.4 wt/aqueous suspension of hemlock cellulose nanocrystals (CNCs) were added to 10 ml of diethyl(polypropoxy)-methylammonium chloride (TEGO® IL P9) from Degussa AG, to form a dispersion. The sample was rotary evaporated to remove water at 80° C. down to 10 mbar.

Then 4 ml of DMF was added to 0.5 g of the dispersion and shaken thoroughly to make homogeneous. This sample was further diluted in DMF and analysed by static light scattering (Zetaziser) and compared with the particle size distribution (by Zetasiser) of the starting CNCs (1 g dispersed in 1 L of water, FIG. 2).

As can be seen from FIG. 2, the ionic liquid dewatering procedure allowed for recovery of nano-sized cellulose. Hence, the ionic liquid dewatering step does not degrade or irreversibly aggregate the cellulose.

### Example 2—Dewatering Cotton CNCs in TEGO® IL P9

30.2 g of a 1.5 wt % aqueous suspension of cotton cellulose nanocrystals (CNCs) were added to 8.9 g of TEGO® IL P9 from Degussa AG to form a dispersion. The sample was rotary evaporated to remove water at 80° C. down to 10 mbar.

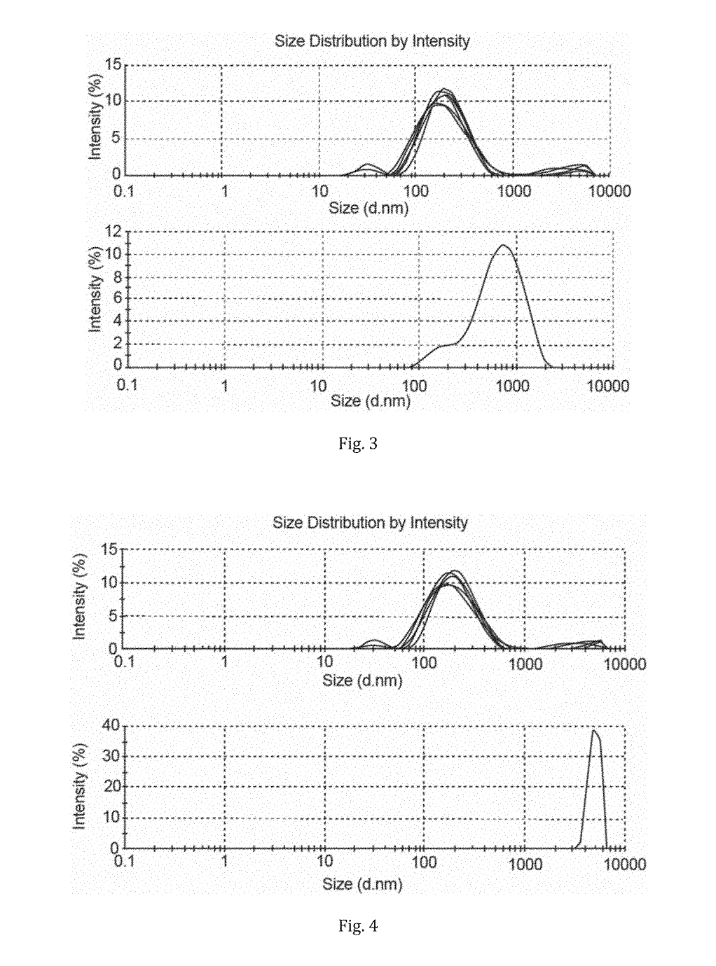

Then 4 ml of DMF was added to 0.5 g of the dispersion and shaken thoroughly to make homogeneous. This sample was further diluted in DMF and analysed by static light scattering (Zetaziser) and compared with the particle size distribution (by Zetasiser) of the starting CNCs (1 g dispersed in 1 L of water, FIG. 3).

As can be seen from FIG. 3, the ionic liquid dewatering procedure allowed for recovery of nano-sized cellulose. Hence, the ionic liquid dewatering step does not degrade or irreversibly aggregate the cellulose.

### Example 3—Dewatering Cotton CNCs in [emim][OTf]

18.7 g of a 1.5 wt % aqueous suspension of cotton cellulose nanocrystals (CNCs) were added to 5.3 g of 1-ethyl-3-methylimidazolium trifluoromethanesulphonate ([emim][OTf]) to form a dispersion. The sample was rotary evaporated to remove water at 80° C. down to 10 mbar.

Then 4 ml of DMF was added to 0.5 g of the dispersion and shaken thoroughly to make homogeneous. This sample was further diluted in DMF and analysed by static light scattering (Zetaziser) and compared with the particle size distribution (by Zetasiser) of the starting CNCs (1 g dispersed in 1 L of water, FIG. 4).

As can be seen from FIG. 4, the ionic liquid dewatering procedure allowed for recovery of micro-sized cellulose particles. Significant aggregation has occurred compared to the starting CNCs although the solutions were still homogeneous. This indicates that [emim][OTf] was not as effective for preventing aggregation.

### Example 4—Dewatering Birch NFC in TEGO® IL P9

14.4 g of a 1.7 wt % aqueous suspension of cotton cellulose nanocrystals (CNCs) were added to 10.0 g of TEGO® IL P9 from Degussa AG to form a dispersion. The sample was rotary evaporated to remove water at 80° C. down to 10 mbar.

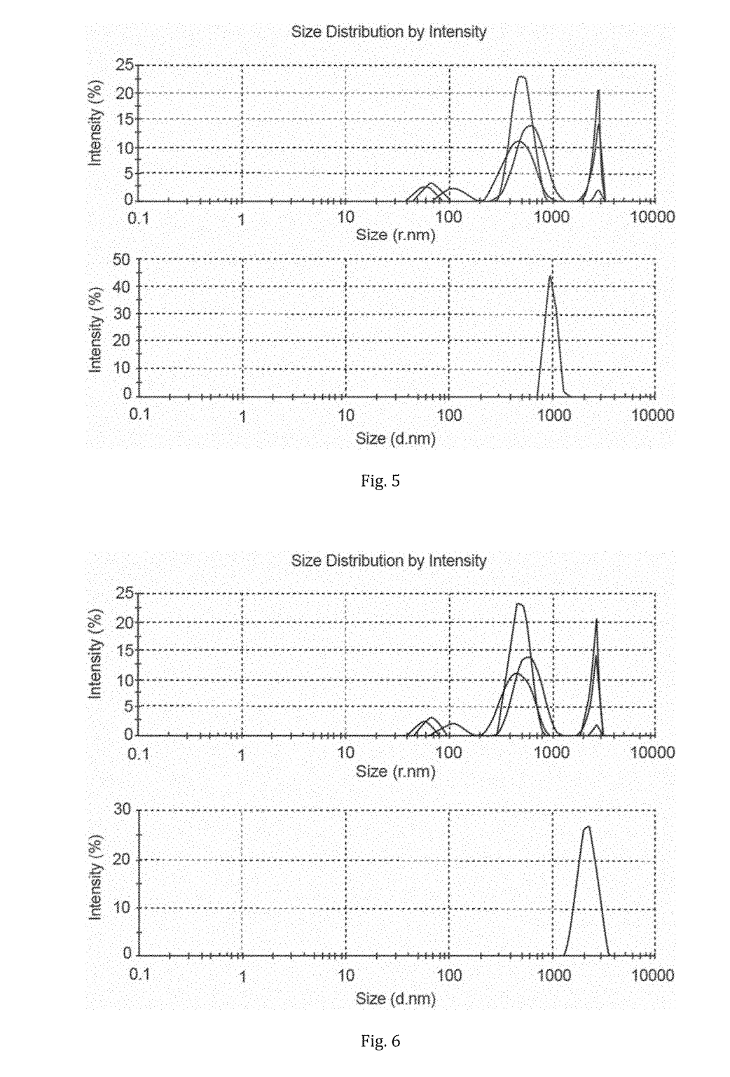

Then 4 ml of DMF was added to 0.5 g of the dispersion and shaken thoroughly to make homogeneous. This sample was further diluted in DMF and analysed by static light scattering (Zetaziser) and compared with the particle size distribution (by Zetasiser) of the starting NFC (1 g dispersed in 1 L of water, FIG. 5).

As can be seen from FIG. 5, the ionic liquid dewatering procedure allowed for recovery of nano to micro-sized cellulose. Hence, the ionic liquid dewatering step does not degrade or irreversibly aggregate the cellulose. Some mild aggregation is occurring but the maximum hydrodynamic radius is still in the nano-scale.

### Example 5—Dewatering Birch NFC in [emim][OTf]

13.7 g of a 1.7 wt % aqueous suspension of cotton cellulose nanocrystals (CNCs) were added to 9.5 g of 1-ethyl-3-methylimidazolium trifluoromethanesulphonate ([emim][OTf]) to form a dispersion. The sample was rotary evaporated to remove water at 80° C. down to 10 mbar.

Then 4 ml of DMF was added to 0.5 g of the dispersion and shaken thoroughly to make homogeneous. This sample was further diluted in DMF and analysed by static light scattering (Zetaziser) and compared with the particle size distribution (by Zetasiser) of the starting NFC (1 g dispersed in 1 L of water, FIG. 6).

As can be seen from FIG. 6, the ionic liquid dewatering procedure allowed for recovery of micro-sized cellulose. Aggregation is not significant enough to cause precipitation but aggregates are clearly forming which show a hydrodynamic diameter just outside the nano-scale. This again shows that [emim][OTf] is not as effective for preventing aggregation.

Water Removal

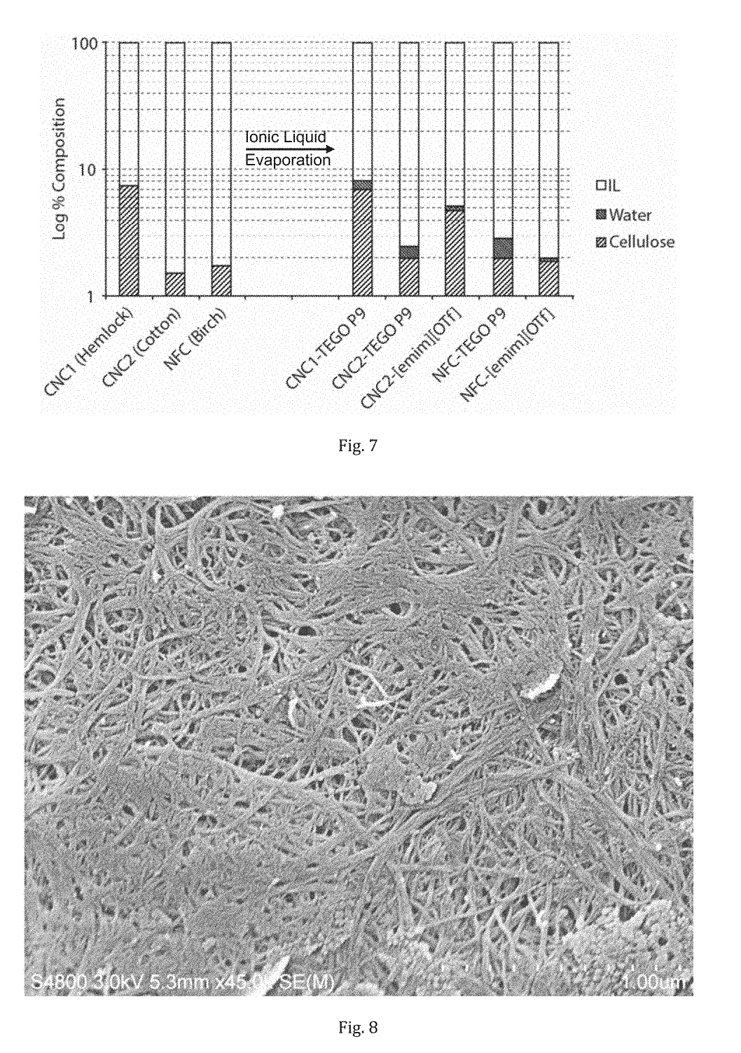

The removal of water from the present nanocelluloses is charted in FIG. 7. This shows the decrease in water content upon introduction into the ionic liquids and evaporation in a rotary evaporator. As can be seen from FIG. 7 almost all water is removed from the ionic liquid mixtures. Residual water is left in the ionic liquids but this may be further removed using the correct process equipment, e.g. thin-film or short-path or falling film evaporation, variable vacuum, temperature and choice of ionic liquid.

An important main advantage over the existing processes is that it is possible to avoid repetitive mixing and centrifugation steps to get the water content below 1 wt %. Most of the water can be removed by evaporation from the ionic liquid mixture, for example, using a thin-film evaporator or short-path distillation. Here it is described that a FILMTRUDER® may be suitable for this process. This has been an enabling technology for evaporation of water from cellulose dopes in the lyocell process and is typically used for removing water from viscous solutions often containing solids. It is a modified thin-film evaporator and minimizes the need for very low vacuums and high temperatures. Naturally, a number of other methods and pieces of equipment can be employed, typically used for high consistency evaporation.

### Example 6—Chemical Modification of [emim][OTf]-NFC Solution

A [emim][OTf]-NFC solution having a water content of 0.1 wt % (by Karl-Fischer analysis) and 1.9 wt % dry pulp content was allowed to stand for 1 month after addition of DMF. No precipitation to any significant degree was observed.

Acetylation of the [emim][OTf]-NFC solution was done directly in the same [emim][OTf]-solution as dewatering. Acetylation was chosen as a model reaction as acetylated cellulose and xylan have already been thoroughly characterized by 2D NMR. The NFC-[emim][OTf] gel (2.28 g of 1.9 wt % cellulose in [emim][OTf]) was acetylated by addition of acetic anhydride (0.149 ml, 3.44 wt eq to nanocellulose) with catalytic DMAP (3.0 mg). The mixture was stirred with a spatula and heated at 80° C. for 22 hr, with intermittent stirring. The mixture was quenched by addition of water (10 ml). The mixture was centrifuged and the solid washed an additional 2 times with water (2*10 ml) and once with methanol (10 ml), to finally dry the sample. Further methanol (10 ml) was added and the solution rotary evaporated to dryness, to give a partly transparent thin film. This was analysed by SEM (FIG. 8). SEM analysis has shown that the fibrillar structure is very much intact. Some fibrils even show down to ˜10-15 nm which seems to correspond to elementary fibrils, based upon ˜5 nm for the sputtering layer and 8.2 Å between adjacent polymer units in the H-bonding plane of the Nishiyama cellulose I-beta crystal structure, published in the Journal of the Americal Chemical Society, 2002, 124, 9074. This clearly shows that, at least, extensive aggregation is avoided.

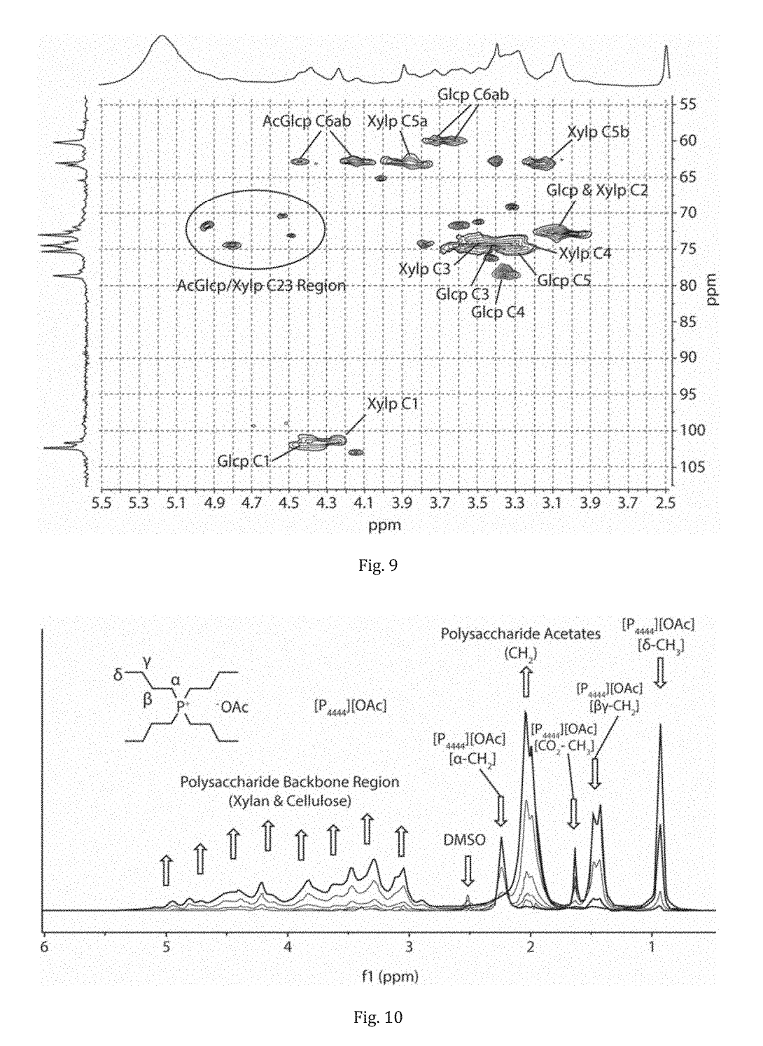

In essence, as can be seen from FIG. 8, NFC is still present, despite [emim][OTf] being the lesser basic of the two ionic liquids, i.e. less ability to H-bond to polysaccharide surfaces. To confirm that the NFC was actually acetylated, ATR-IR showed a significant CO stretch. However, this does not indicate if cellulose has been modified or merely the surface adsorbed xylan, which may gel or even dissolve and re-precipitate, during the modification procedure. Therefore, the Ac-NFC film was completely dissolved in 1:4 [P₄₄₄₄][OAc]/DMSO-d6 (100° C. 30 min), according to a procedure published by Deb in Green Chemistry, and an HSQC NMR was collected on the sample (FIG. 9). Expansion of the ¹H and ¹³C cellulose biopolymer region clearly shows that at least cellulose C6 & C2 and xylan C2 & C3 are chemically modified, compared to well-known literature assignments of acetylated cellulose and xylan. Assignments of the acetylated xylan resonances were also performed by taking the AcNFC film and heating in DMSO-d6 at 80° C. for 1 hr. This allowed for extraction of the partially acetylated xylan from the AcNFC fibre, thus allowing for discrimination between the cellulosic and hemicellulosic resonances. Signals corresponding to acetylated cellulose and xylan are clear, confirming surface modification of both the surface adsorbed xylan and insoluble cellulose.

Acetylation, with the acetate signal at 2 ppm, can also clearly be shown by running a diffusion-ordered spectroscopy (DOSY) gradient array. Stacking and normalisation of the ¹H gradient array shows the disappearance of the fast-diffusing low molecular weight species (DMSO and ionic liquid) and emergence of the slow-diffusing polymeric material, with acetate resonance firmly placed at 2 ppm (FIG. 10). Minor traces of [emim][OTf] can be observed in the ¹H and ¹³C spectra showing that further washing is required to remove ionic liquid traces in some cases.

### INDUSTRIAL APPLICABILITY

The present method is useful for dewatering nanocellulose of any origin as well as other water soluble or hydrophilic polymers.

Non-aggregated nanocelluloses having low or very low water contents are achieved. Nanocellulose obtained by the present technology can be further processed. Such steps include compositing of the modified or unmodified nanocellulose, grafting of the nanocellulose using polymers or nanoparticles, chemical modification of the surface, modification using inorganic compounds or surfactants, biochemical modification and regeneration of modified or unmodified nanocelluloses into particular shapes, such as films, fibres or other low aspect-ratio shapes.

In addition, the dispersible materials may be used as additives in a wide range of processes, they may be applied to surfaces as paints or used to scavenge impurities for filtration.

### REFERENCE SIGNS LIST

1 Aqueous Nano Cellulose
2 Mixing
3 Evaporation
4 Mixing
5 Centrifugation
6 Dry Nano Cellulose
7 Co-Solvent Evaporation
8 Compositing
9 Chemical Modification
10 Regeneration

### CITATION LIST

### Patent Literature

WO2014072886A1
WO2012156880A1
WO2014096547A1
WO2015068019A1
EP2815026A1
WO2012089929A1
WO2010019245A1
WO2009101985A1

### Non-Patent Literature

Soft Matter, 2012, 8, 8338
J. Am. Chem. Soc., 2002, 124, 9074
Green Chem., 2016, 18, 3286

1. A method of dewatering water soluble polymers or hydrophilic polymers, comprising the steps of:
providing an aqueous suspension formed by the polymer in water;
mixing the aqueous suspension with an ionic liquid or eutectic solvent which is capable of hydrogen bonding to at least a part of the functional groups on the polymer forming a modified suspension; and
physically separating water from the modified suspension in order to dewater the polymer.

2. The method according to claim 1 for dewatering nanocellulose, comprising the steps of:
providing an aqueous suspension formed by nanocellulose in water, said nanocellulose having free hydroxyl groups;
mixing the aqueous suspension with an ionic liquid or eutectic solvent which is capable of hydrogen bonding to at least a part of the free hydroxyl groups to form a modified suspension; and
physically separating water from the modified suspension in order to dewater the nanocellulose.

3. The method according to claim 1, wherein water is separated from the modified suspension by evaporation.

4. The method according to claim 2, wherein the ionic liquid or eutectic solvent is capable of stabilizing the surface of the nanocellulose so as to prevent agglomeration of nanocellulose when water is evaporated off the aqueous suspension.

5. The method according to claim 1, wherein the ionic liquid or eutectic solvent is essentially non-volatile at the conditions at which water is evaporated off the modified suspension.

6. The method according to claim 1, wherein the ionic liquid or eutectic solvent essentially does not dissolve cellulose at the conditions at which it is mixed with the aqueous suspension and at which water is evaporated off, said ionic liquid or eutectic solvent preferably being miscible with water.

7. The method according to claim 1, wherein the ionic liquid or eutectic solvent is mixed with the aqueous suspension at a weight ratio of about 10 to 100 parts of ionic liquid or eutectic solvent to 100 to 10 parts of water of the aqueous suspension, preferably at a weight ratio of about 1 to 20 parts of ionic liquid or eutectic solvent to 99 to 80 parts of aqueous suspension.

8. The method according to claim 1, wherein the ionic liquid or eutectic solvent is selected from the group of:
diethyl(polypropoxy)methylammonium chloride,
1-ethyl-3-methylimidazolium trifluoromethanesulphonate, and
choline chloride/urea eutectic mixtures and combinations thereof.

9. The method according to claim 2, wherein the step of mixing the aqueous suspension of nanocellulose with ionic liquid is carried out at a first pressure and at a first temperature which is higher than the freezing point of water and lower than the boiling point of water.

10. The method according to claim 9, wherein the step of evaporating off water from the modified suspension is carried out at a second temperature, which is higher than the first temperature.

11. The method according to claim 9, wherein the step of evaporating off water from the modified suspension is carried out at second pressure, which is the same as or lower than the first pressure.

12. The method according to claim 1, wherein the step of evaporating off water is carried out at a pressure of 0.001 to 1 bar(a), for example 0.1 to 750 mbar(a), advantageously 0.5 to 500 mbar(a), in particular 1 to 100 mbar(a), and preferably at a temperature corresponding to the boiling point of water at that pressure.

13. The method according to claim 1, wherein the step of evaporating off water from the modified suspension is carried out in a thin-film evaporator, a rotary evaporator, a falling film evaporator, a filmtruder evaporator, a kugelrohr evaporator or a short- or long-path evaporator or a corresponding distillation device.

14. The method according to claim 2, wherein nanocellulose is selected from the group of:
nanowhiskers,
microfibrillated cellulose,
nanocrystalline cellulose,
nanofibrillated cellulose, and
bacterial nanocellulose and combinations thereof.

15. The method according to claim 2, wherein the concentration of nanocellulose in the aqueous suspension of nanocellulose is such that the suspension is free-flowing or it is pumpable before or after the mixing of the aqueous suspension with the ionic liquid or eutectic solvent.

16. The method according to claim 15, wherein the aqueous suspension of nanocellulose contains about 0.1 to 45%, in particular about 1 to 15%, for example 1 to 10% of nanocellulose, calculated from the weight of the aqueous suspension.

17. The method according to claim 2, wherein the residue obtained after evaporation of water, comprising non-agglomerated nanocellulose and ionic liquid or eutectic solvent, is recovered and subjected to further processing as such.

18. The method according to claim 2, wherein the residue obtained after evaporation of water, comprising non-agglomerated nanocellulose and ionic liquid or eutectic solvent, is recovered and the ionic liquid or deep eutectic solvent is separated from the residue.

19. The method according to claim 2, wherein the residue obtained after evaporation of water, comprising non-agglomerated nanocellulose and ionic liquid or eutectic solvent, is recovered and subjected to solvent exchange.

20. The method according to claim 2, wherein the residue obtained after evaporation of water, comprising non-agglomerated nanocellulose and ionic liquid or eutectic solvent, is recovered and regenerated as fibres, films or other molded shapes or objects by addition of solvents, such as protic solvents or mixtures thereof, to wash away the ionic liquid or eutectic solvent, said fibres, films or other molded objects.

21. The method according to claim 2, wherein the residue obtained after evaporation of water, comprising non-agglomerated nanocellulose and ionic liquid or eutectic solvent, is subjected directly to chemical modification where the cellulose surfaces are modified but the ionic liquid remains unreacted.

22. The method according to claim 19, wherein the residue is mixed with an organic solvent selected from the group of N,N-dimethylformamide, dimethylsulfoxide, N,N-dialkylureas, N-alkylpyrrolidones, dialkylcarbonates, gamma-valerolactone and acetone, or other similar dipolar aprotic solvents to form a mixture, and the solid matter is optionally separated from the mixture to provide dry nanocellulose.

23. The method according to claim 22, wherein the residue is mixed with an organic solvent at a molar ratio of 0.1 to 10:1 of organic solvent to the ionic liquid or eutectic solvent of the residue.

24. The method according to claim 22, wherein the liquid phase of the mixture is recovered and recycled.

25. The method according to claim 1, further comprising producing nanocellulose containing less than about 10% water, in particular less than 5% water, for example less than 1% water, calculated from the total weight of the nanocellulose.

26. The method according to claim 1, further comprising producing nanocellulose containing less than about 10%, in particular less than 5%, for example less than 1% aggregated nanocellulose matter, calculated from the total weight of the nanocellulose.

27.-29. (canceled)
